(19) United States
(12) Patent Application Publication
(10) Pub. No.: US 2009/0135922 A1
(43) Pub. Date: May 28, 2009

(54) POWER SAVINGS IN OFDM-BASED WIRELESS COMMUNICATION

(76) Inventors: Chang Yong Kang, Chandler, AZ (US); David G. Leeper, Scottsdale, AZ (US)

Correspondence Address: INTEL CORPORATION;c/o CPA Global, P.O. BOX 52050, MINNEAPOLIS, MN, 55402, US

(21) Appl. No.: 11/946,496

(22) Filed: Nov. 28, 2007

(51) Int. Cl. H04L 23/02; H04J 1/00

(52) U.S. Cl. 375/260; 370/343

(57) ABSTRACT

In a wireless communications system using Orthogonal Frequency Division Multiplex technology, changing the nature of the signals being transmitted/received may be used to reduce power consumption. In one embodiment, reducing the number of carriers that are being employed may be used to decrease power consumption by permitting a reduced clock rate for driving some of the circuitry. Similarly, increasing the duration of the symbols used to encode the data may be used to reduce the clock rate. Other power savings may be found by using single-rail processing, allowing some of the signal processing circuitry to simply be shut down.

### BACKGROUND

Ultrawideband wireless communications enable improved data throughput when compared with narrowband techniques. In particular, Orthogonal Frequency Division Modulation (OFDM) permits high data rates to be achieved over wireless networks because different parts of the data may be split up and simultaneously sent over separate carriers, each carrier operating at a different frequency. The data may then be re-combined at the receiver. The frequencies, typically closely spaced, are chosen so that the spectral distribution of each carrier becomes null at the other carriers' spectral peaks, and their signals will therefore not interfere with each other even though the frequencies are closely spaced. This frequency spacing is referred to as orthogonal frequencies.

By spreading the data across multiple carriers in this manner, high data rates may be achieved. For example, in a modulation technique such as quadrature phase shift keying (QPSK), each two bits of a 256-bit data string may be simultaneous transmitted on 128 carriers, taking only the time required to transmit 2 bits. However, simultaneously transmitting over multiple carriers in this manner, while greatly improving overall throughput, also significantly increases the power required in both the transmitter and receiver. Some low data-rate communication devices don't need the high bandwidth, but are battery powered and are very sensitive to power consumption. These types of devices make very inefficient use of power when they are forced to follow a standard OFDM-based communications protocol.

### BRIEF DESCRIPTION OF THE DRAWINGS

Some embodiments of the invention may be understood by referring to the following description and accompanying drawings that are used to illustrate embodiments of the invention. In the drawings:

FIGS. 1A, 1B, and 1C show data maps of data communicated between a base station and one or more mobile stations using OFDM, according to an embodiment of the invention.

FIG. 2 shows a technique for increasing the number of bands that are available for Multiband OFDM communications, according to an embodiment of the invention.

FIG. 3 shows a flow diagram of a method for transmitting an OFDM frame, according to an embodiment of the invention.

FIG. 4 shows a flow diagram of a method for receiving an OFDM frame, according to an embodiment of the invention.

FIG. 5 shows functional operations in the transmit and receive chains of a wireless communications device, according to an embodiment of the invention.

FIG. 6 shows a system containing a base station and a mobile station, according to an embodiment of the invention.

FIG. 7 shows a flow diagram of a method of performing single-rail operation, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a tangible storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile station” is used to describe a wireless communications device that may be in motion while it is communicating. The term “base station” is used to describe a wireless communications device that is used to control communications with multiple mobile stations, and is generally (though not necessarily always) fixed in place while communicating.

Various embodiments of the invention may reduce the power required for OFDM communications by using only a subset of the carriers that are available, and/or by processing only part of the components of the signals that are received. This can be achieved in various ways, such as 1) changing the way the data is transmitted over the carriers, thereby reducing the power required to process the signals, 2) using single-rail operation, to eliminate the need for half of the analog-to-digital converters (ADC) and/or half the digital-to-analog converters (DAC). In addition, by using only the upper (or lower) half of the carriers, the remaining half may be treated as a separate carrier grouping, and may therefore be used as a separate band in multi-band OFDM communications.

### Reducing Number of Carriers in the Transmitted Signal

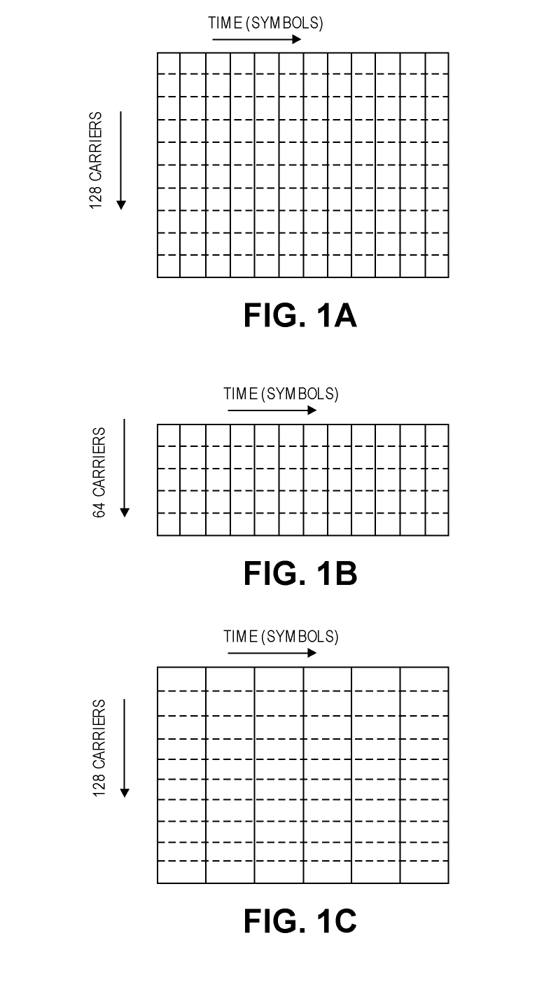

FIGS. 1A, 1B, and 1C show data maps of data communicated between the base station and mobile station using OFDM, according to an embodiment of the invention. In OFDM, different parts of the data are communicated on different carriers at the same time. In the example of FIG. 1A, 128 carriers are used, shown along the vertical axis, and separated by dashed lines. (To avoid cluttering up the drawing, only 10 carriers are actually illustrated, but this principle may be extended to the entire 128 carriers.) The horizontal axis shows the passage of time, divided into an element commonly called symbols. A symbol may represent the amount of time it takes to transmit a defined amount of data. For example, in quadrature phase shift keying (QPSK), two bits may be encoded into a single symbol by shifting the phase of a single cycle of a sine wave by multiples of 90 degrees. In this example, the spacing between adjacent vertical lines in the map may represent the time it takes to transmit two bits on a carrier, so the entire 128 carriers could transmit 256 bits during one symbol time. An additional 256 bits could be transmitted during the second symbol, another 256 during the third symbol, etc. QPSK is used in these examples, but any feasible modulation technique may be used in various embodiments of the invention.

FIG. 1B shows the number of carriers being reduced to 64, using the same size symbols as FIG. 1A. Following the same 2 bits-per-symbol example, a total of 128 bits may be transmitted per symbol when 64 carriers are used. This is only half the total data throughput of FIG. 1A, but the power consumption to process that data is reduced. The reduced subset of carriers are assumed to be adjacent carriers. For example, trying to combine some of the highest frequency carriers with some of the lowest frequency carriers from FIG. 1A into a single subset may not produce the same beneficial results.

FIG. 1C shows the same 128 carriers as FIG. 1A, but the symbol duration has been doubled over that of FIG. 1A. Again assuming 2 bits per carrier per symbol, a total of 256 bits per symbol may be transmitted, but each symbol takes twice as long to transmit (or receive), so the total data throughput in FIG. 1C may be half that of FIG. 1A, and equal to that of FIG. 1B.

Two relationships in OFDM communications are dictated by the nature of the technology:

(symbol duration)=1/(tone spacing) 1)

(sampling rate)=(tone spacing)×(number of sub-carriers) 2)

For example, in a standard promulgated for WiMedia, the symbol duration (the time to transmit a signal encoding a defined number of bits, e.g. 2 bits) is 242.2 ns, the tone spacing (the frequency separation between adjacent sub-carriers) is 4.125 MHz, the number of sub-carriers used is 128, and the sampling rate (how often the baseband signal must be sampled to re-create the original signals that were modulated onto the carriers) is 528 MHz. Assuming the tone spacing remains unchanged, the sampling rate is proportional to the number of sub-carriers being used. Reducing the number of sub-carriers therefore can cause a proportionate reduction in the sampling rate.

In signal processing circuitry, the sampling rate tends to control the clock frequency that is used to operate that circuitry. Since power consumption by CMOS circuitry is generally proportional to how often the transistor gates switch from one state to another, power consumption in signal processing circuitry may tend to be approximately proportional to the frequency of the clock driving that circuitry. Thus, reducing the number of carriers being used in an OFDM communication, as shown in FIG. 1B, makes it possible to reduce the sampling rate of the processing circuitry, which makes it possible to reduce the circuit clock rate of that circuitry, which in turn can produce a corresponding reduction in power consumption. In addition, reducing clock speed in CMOS circuitry makes it possible to reduce the operating voltage for that circuitry. Since power consumption is proportional to the square of the voltage, this voltage reduction may have an even more pronounced impact on reducing power consumption.

Examining FIG. 1C and the two equations above, it can be seen that increasing the symbol duration allows the tone spacing to be reduced (the carriers may be closer together in frequency), which also reduces the minimum allowable sample rate. This reduced sample rate may in turn produce lower power consumption in the processing circuitry. Although the two techniques (reducing the number of carriers or increasing symbol size) are shown as two independent solutions, some embodiments may combine these two techniques in a single device, thus further increasing the total power savings that can be realized.

In some high-throughput devices, reducing the number of carriers or increasing symbol duration may not be advantageous. But in other devices, such as low throughput devices, and/or battery powered devices in which lower power consumption is more important than higher data rates, either or both of these techniques may be beneficial. In some networks, the base station may have to communicate with a mixture of mobile stations, containing devices that can benefit from these techniques and devices that cannot. Further, some network devices may use older technology that is unable to take advantage of these techniques, even if it would be beneficial. In such cases, the base station may need to be able to switch between: 1) standard carrier numbers and symbol durations, 2) reduced carrier numbers, 3) increased symbol durations, or 4) a combination of 2) and 3). Since these techniques can use the same hardware and the same protocols as conventional systems, the same system should be able to handle both these techniques and the more conventional techniques of legacy systems.

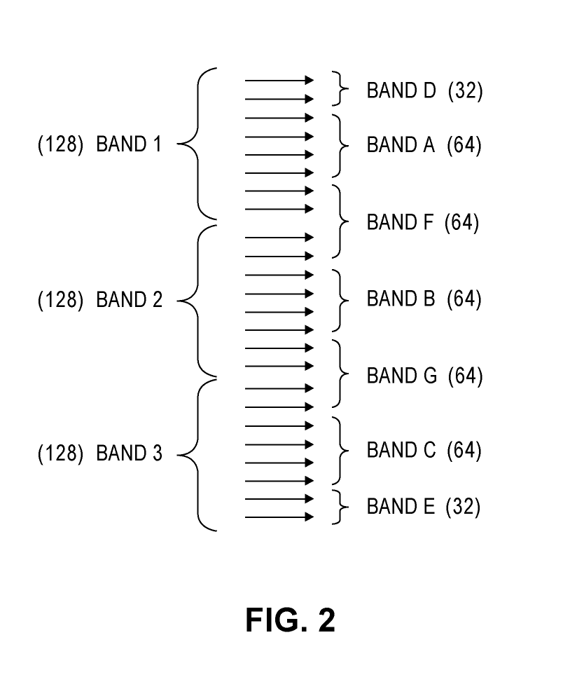

Further benefits may be realized by carefully choosing the particular carriers that are selected in the technique of FIG. 1B. FIG. 2 shows a technique for increasing the number of bands that are available for Multiband OFDM (MB-OFDM) communications, according to an embodiment of the invention. MB-OFDM uses multiple bands of frequencies, each band containing a different OFDM group of carriers. The devices can then switch between these bands at regular or irregular intervals. Such ‘band-hopping’ can have advantages in overcoming problems caused by the ever-changing channel conditions that are typical of wireless communications. FIG. 2 shows three such bands, labeled Band 1, 2, and 3, each containing 128 carriers, with each band covering a different part of the frequency spectrum. In a conventional system, a base station and one or more mobile stations may use the 128 carriers of Band 1 for a while, and then switch to the 128 carriers of Band 2 or 3. Repeated hopping from one band to another may be continued. More bands may also be employed. In general, having a larger number of bands available for use will increase the potential benefits of band-hopping. Alternately, the band not being used by one set of mobile stations could be used by another set of mobile stations.

If the number of carriers being used is to be reduced in the manner previously described, then the unused carriers may be assigned to another band. In the example shown in FIG. 2, each of 128-carrier bands 1, 2, and 3 have been shrunk to 64-carrier bands, now labeled as bands A, B, and C, respectively. Since the center frequency of each band remains unchanged, many of the processing parameters may stay the same. However, the upper 32 and lower 32 carriers of each of Bands 1, 2, and 3 are now unused, resulting in inefficient use of the available bandwidth. By creating a new center frequency, the upper 32 carriers of Band 1 may be reassigned to a new Band D. Similarly, the lower 32 carriers of Band 3 may be used to form a new Band E, with a different center frequency. Other unused carriers may similarly be reassigned. In some instances, if Bands 1, 2, and 3 are adjacent to each other, such that the lower carriers of one band and the upper carriers of another band have the correct spacing with respect to each other, these may be combined into a single new band. In the example, the lower 32 carriers of Band 1 and the upper 32 carriers of Band 2 have been reassigned as a 64-carrier Band F. Similarly, the lower 32 carriers of Band 2 and upper 32 carriers of Band 3 have been reassigned as 64-carrier Band G. If the spacing between the carriers of the different bands is does not permit this, then the unused carriers may be reassigned into new 32-carrier bands, as was done to create Bands D and E. Such divisions, combinations, and reassignments of bands for MB-OFDM, may be performed in any feasible combination as needed, and center frequencies may be shifted as needed to take advantage of the newly-created bands. For example, a 128-carrier band might be divided into four 32-carrier bands, although the original center frequency could not be re-used for any of them. The newly-formed bands shown are mutually exclusive, i.e., bands A, B, C, D, E, F, and G do not contain any of the same carriers.

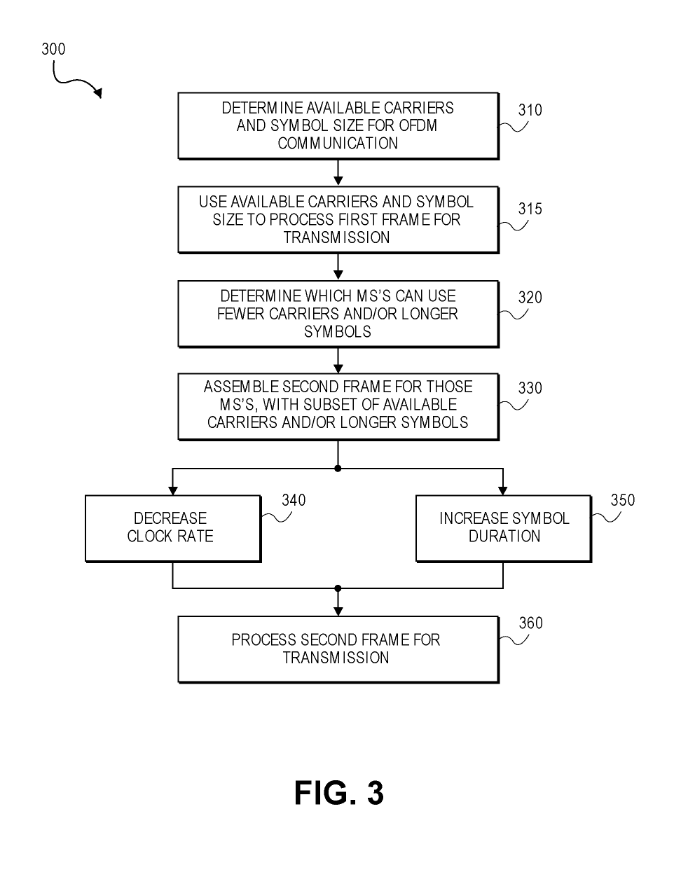

FIG. 3 shows a flow diagram of a method for transmitting an OFDM frame, according to an embodiment of the invention. For this example, the method is being performed by a base station, but other embodiments may perform the method in another type of wireless communications device. In flow diagram 300, at 310 the base station may determine how many carriers are available for transmitting an OFDM frame. In some embodiments the number of carriers, and their frequencies, may be pre-determined external to the base station, such as by an industry standard. In some embodiments, the symbol duration, or at least the shortest feasible symbol duration, may be determined by channel conditions. At 315, a first frame may be processed for transmission, using the available carriers and the symbol size determined at 310. At 320, the base station may determine which mobile stations are to use only a subset of these available carriers and/or are to use longer symbol durations, in a subsequent frame. This determination may be based on various criteria, such as but not limited to: 1) a mobile station may only be capable of processing a smaller number of OFDM carriers, 2) the amount of data going to/from a mobile station may be small enough to need only a smaller number of OFDM carriers or a lower data rate, 3) the remaining charge in the battery of the mobile station may indicate that reduced power consumption in the mobile station is desirable, 4) etc.

At 330, the base station may assemble a second OFDM frame directed to those mobile stations selected at 320, using only the reduced subset of available carriers and/or using longer symbol durations. The base station may then lower the clock rate for it's DAC at 340, and where appropriate may also set an increased symbol duration for the frame at 350. Using these new parameters, the second frame may be processed for transmission at 360.

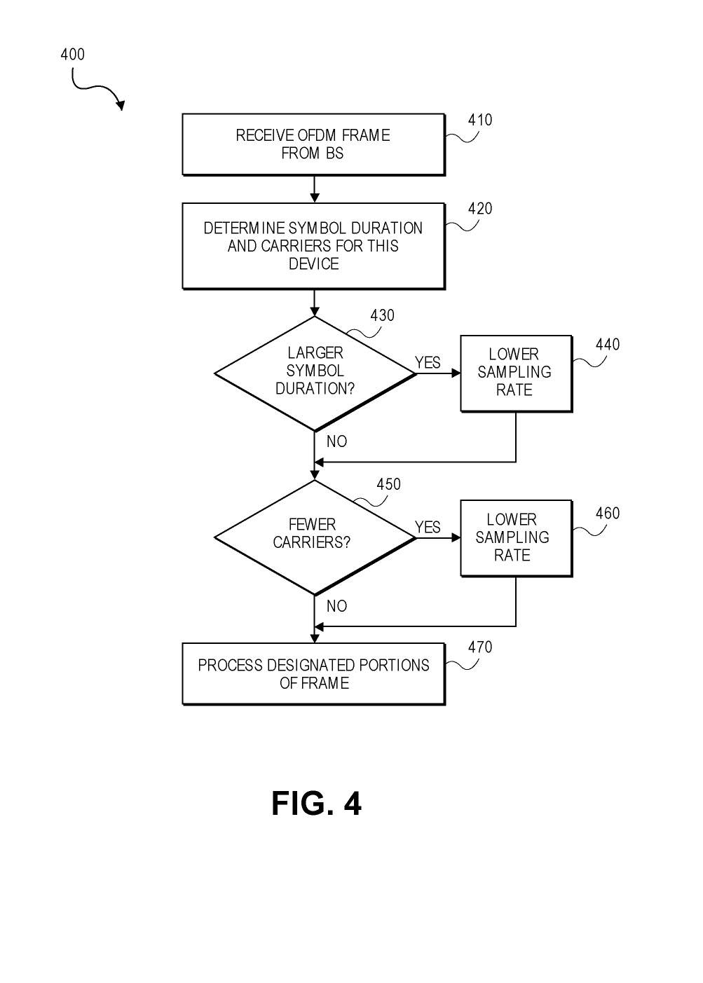

FIG. 4 shows a flow diagram of a method for receiving an OFDM frame, according to an embodiment of the invention. In this example, the method is being performed by a mobile device, but other embodiments may perform the method in other types of wireless communications devices. In flow diagram 400, at 410 the mobile station may receive an OFDM frame. After determining, at 420, the appropriate symbol duration and the number of carriers being used for communicating with this device, the mobile station may determine if it can use a reduced sampling clock rate based on a longer symbol duration or a smaller number of carriers being used, when compared with the standard frame.

If a longer than normal symbol duration is being used, as determined at 430, the sampling clock rate may be lowered at 440 to save power when processing the frame. Similarly, if only a sub-set of available carriers are being used, as determined at 450, the sampling clock rate may be lowered at 460 to save power when processing the frame. If both a longer symbol duration and a reduced set of carriers are being use, then the cumulative reduction in sampling rate may be used. At 470, the portions of the frame that are directed to this mobile device may be processed, using the lowered sampling clock rate.

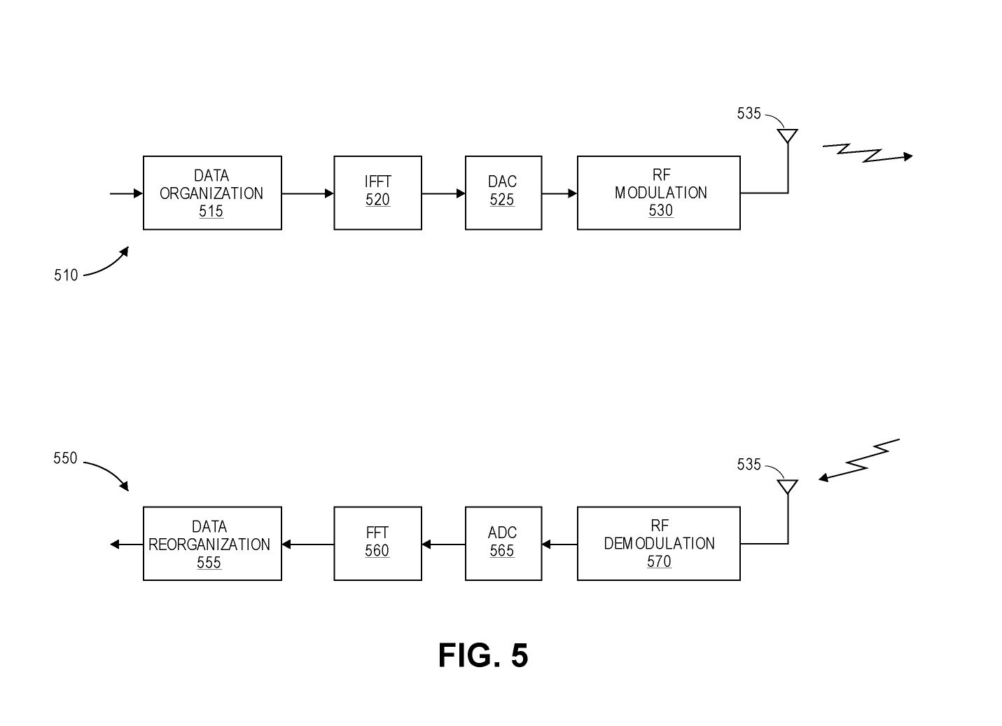

FIG. 5 shows functional operations in the transmit and receive chains of a wireless communications device, according to an embodiment of the invention. Transmit chain 510 and receive chain 550 may be contained within a single wireless device. The indicated functions may be performed in hardware, software, firmware, or any combination thereof. Further, different functions might share some of the same hardware, firmware, and/or software as needed, both between the transmit and receive chains, and within each of those chains. The illustrated embodiment shows the transmission and receive chains sharing the same antenna 535, but other embodiments might use separate antennas for each. Further, multi-antenna systems might be used for either or both of the transmit and receive functions.

In the transmit chain 510, the data to be transmitted may be organized at 515. Such operations may comprise things such as, but not limited to: 1) dividing the data into frames, 2) adding, to the basic data, things that are needed for reliable and unambiguous communication, such as preambles, headers, checksums, etc., and 3) separating the data into segments for the different carriers and symbols. The data to be transmitted may be processed through an Inverse Fast Fourier Transform (IFFT) at 520 to produce a composite data stream representing the combined data for all the carriers. For example, a 128-point IFFT may be used if 128 carriers are to be used. At 525, a DAC may convert this digital composite data stream into an analog baseband signal. The analog baseband signal may then be modulated onto a radio frequency (RF) signal at 530, and transmitted through antenna 535.

In the receive chain 550, the RF signal received through antenna 535 may be demodulated into a baseband signal at 570, and the baseband signal converted into a composite digital data stream by the ADC at 565. At 560 a Fast Fourier Transform (FFT) may then be used to convert the composite data stream into the separate data streams that had been transmitted on each of the carriers. The resulting data may then be reorganized into its relevant parts at 550. This data reorganization may include things such as, but not limited to: 1) combing the contents of the different carriers and symbols into their original relationships, 2) removing preambles, headers, checksums, etc., and 3) combing the contents of frames, packets, etc. into their original order.

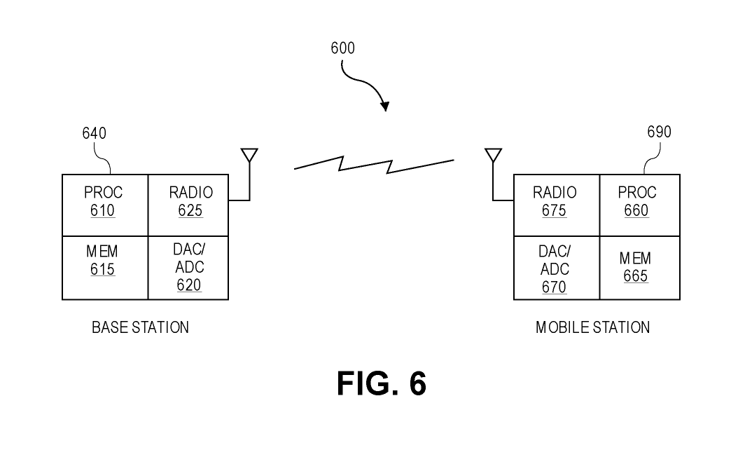

FIG. 6 shows a system containing a base station and a mobile station, according to an embodiment of the invention. In the illustrated system 600, the base station 640 and the mobile station 690 may each contain similar components internally coupled to each other, but configured to operate in slightly different ways. Each has at least one processor (610, 660) to perform general purpose processing and data manipulation, a memory (615, 665) to contain the relevant programs and data, a DAC and ADC (620, 670) to convert between analog and digital formats, and a radio (625, 675) to convert the analog data to/from a modulated RF signal. In general, the base station will have more capability, processing power, memory, etc., than the mobile station, but this is not a requirement of some embodiments of the invention.

### Single-Rail Operation for Internal Processing

As previously mentioned, QPSK modulation may be used, thereby encoding 2 data bits for each carrier per symbol. This indicates that there is no symmetry assumed for the distribution of the carriers, and therefore, when they are transformed via IFFT, the time domain signal will be complex, having both real and imaginary parts. This typically leads to the so-called ‘dual-rail’ implementation that requires two ADC's and two DAC's, together with dual-rail (I-Q) modulation/demodulation in the radio circuitry. The properties of the FFT dictate that the time-domain signal will be real if its counterpart in the frequency domain is conjugate-symmetric. Therefore, conversely, it is possible to obtain real time-domain signals by making the frequency-domain carriers conjugate-symmetric, in which case half of the carriers are merely copied (after phase rotation) from the other half, carrying no further information.

By doing this, all the time-domain processing, including ADC/DAC and radio, becomes single-railed. This allows the radio to turn off half of the dual-rail circuitry at the expense of reducing the data rate by half. Half of the ADCs and DACs may therefore be turned off, as may the interpolation/decimation filters. ADCs and DACs typically consume a great deal of power (by comparison to the rest of the circuitry), and this therefore represents a significant power savings. In addition one rail of reconstruction and anti-aliasing filters can be turned off, as can be one channel of the I-Q modulation/demodulation circuitry.

Because not all devices will be able to handle these changes, compatibility with legacy devices should be maintained. By leaving the dual-rail circuitry in place, but shutting down the half that is not necessary for a given operation, a device may be able to handle both dual-rail and single-rail operation by simply providing or not providing power to the appropriate circuitry. In this context, ‘not providing power’ may mean one, some, or all of: 1) stopping the clock signal that causes the relevant digital circuitry to switch states, 2) removing operating voltage to the relevant circuitry, and 3) reducing the operating voltage level to the relevant circuitry.

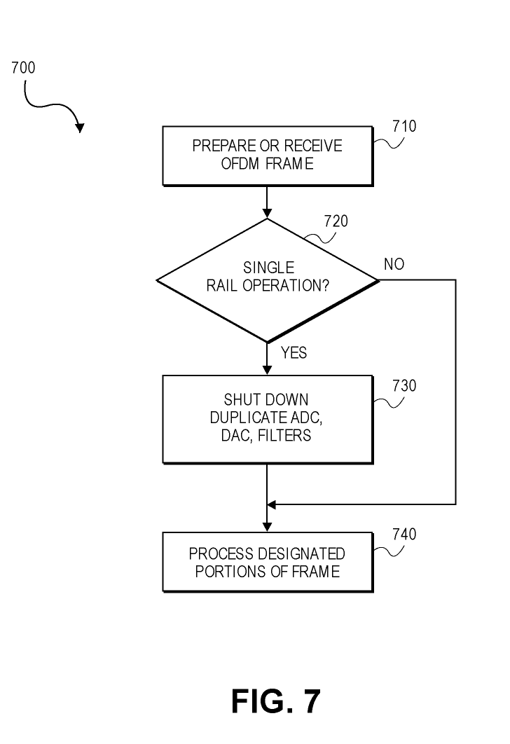

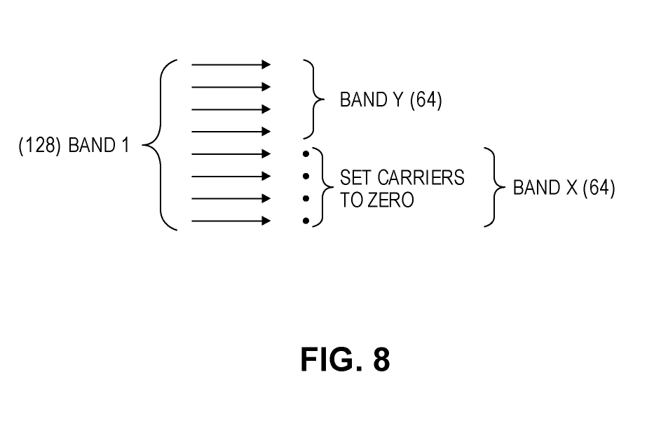

FIG. 7 shows a flow diagram of a method of performing single-rail operation, according to an embodiment of the invention. In flow diagram 700, at 710 a wireless communications device may either prepare an OFDM frame for transmission, or receive an OFDM frame. If single-rail operation is determined to be appropriate at 720, the device may shut down the portions of the circuitry that are unnecessary in single-rail operation, such as the DAC, ADC, filters, etc. Shutting down may comprise various techniques, such as reducing or turning off the operating voltage, reducing or turning off the clock, etc., to the affected circuitry. At 740, the remaining circuitry may be used to process the frame.

### Single Side-Band Modulation

FIG. 8 shows a single side-band modulation operation, according to an embodiment of the invention. In the single side-band (SSB) technique, all the carriers in the lower half (or alternately, the upper half) of the OFDM band may be set to zero, so that there is essentially no signal sent on those carriers. The example of FIG. 8 shows the carriers in the lower half of Band 1 being set to zero, so that essentially no energy is being transmitted on those carriers. The carriers in the upper half of Band 1 remain intact, and are re-labeled as Band Y. This reduces the total number of useable carriers in the band by half, with similar benefits as described for FIG. 2 (lower sampling clock rate, with the associated reduction in power consumption). However, instead of eliminating the highest and lowest carriers, leaving the middle carriers untouched and still centered around the same center frequency, SSB eliminates all the carriers on one side of the center frequency.

Since the lower carriers are unused in this example, they can be redefined as a new band, labeled as Band X, to be used in a future transmission. Band X would be created by setting the upper carriers of Band 1 to zero, just the opposite to that shown in FIG. 8, and modulating data onto the lower carriers. In MB-OFDM, the base station and mobile station may ‘hop’ between Band X and Band Y (and of course between other bands not shown in FIG. 8). This SSB approach essentially doubles the number of bands available for MB-OFDM, with each band using only half the number of carriers as the original band.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. A method, comprising:
processing a first orthogonal frequency division multiplexing (OFDM) frame for wireless communications, the first OFDM frame based on a first set of radio frequency (RF) carriers and a first symbol duration;
processing a second OFDM frame for wireless communications, the second OFDM frame based on a second set of RF carriers and a second symbol duration;
using a slower clock rate for the second frame than the first frame, in at least a portion of circuitry used for said processing of the first and second frames;
wherein the second frame is different than the first frame in at least one of the following ways:
the second set of RF carriers is a first subset of adjacent RF carriers from the first set of RF carriers; and
the second symbol duration is greater than the first symbol duration.

2. The method of claim 1, wherein:
said processing the first frame comprises processing the first frame after reception of the first frame and said processing the second frame comprises processing the second frame after reception of the second frame; and
said using the slower clock rate comprises using a slower clock rate for an analog-to-digital converter.

3. The method of claim 2, wherein said processing the first and second frames takes place in a mobile station.

4. The method of claim 1, wherein:
said processing the first and second frames comprises processing the first and second frames for transmission; and
said using the slower clock rate comprises using a slower clock rate for a digital-to-analog converter.

5. The method of claim 4, further comprising:
determining a set of wireless communications devices to be targeted by the second frame, each device in the set of wireless communications devices determined to be able to process the second frame at a lower clock rate than needed for processing the first frame.

6. The method of claim 4, wherein:
said wireless communications comprise multi-band OFDM (MB-OFDM) communications;
said first subset of adjacent RF carriers from the first set of RF carriers is defined as a first band of the MB-OFDM communications, and a second subset of adjacent RF carriers from the first set of RF carriers is defined as a second band of the MB-OFDM communications.

7. The method of claim 1, wherein the second set of RF carriers is created by using single side-band modulation.

8. An apparatus, comprising
a wireless communications device for communicating using orthogonal frequency division multiplexing (OFDM) techniques, the device comprising a processor and a radio coupled to the processor, the device to:
process a first orthogonal frequency division multiplexing (OFDM) frame for wireless communications, the first OFDM frame based on a first set of radio frequency (RF) carriers and a first symbol duration;
process a second OFDM frame for wireless communications, the second OFDM frame based on a second set of RF carriers and a second symbol duration;
use a slower clock rate for the second frame than the first frame, in at least a portion of circuitry used for said processing of the first and second frames;
wherein the second frame is different than the first frame in at least one of the following ways:
the second set of RF carriers is a first subset of adjacent RF carriers from the first set of RF carriers; and
the second symbol duration is greater than the first symbol duration.

9. The apparatus of claim 8, wherein:
the wireless communications device is to process the first frame after reception of the first frame and to process the second frame after reception of the second frame; and
the slower clock rate is to be used on an analog-to-digital converter.

10. The apparatus of claim 9, wherein the wireless communications device comprises a mobile station.

11. The apparatus of claim 8, wherein:
the wireless communications device is to process the first and second frames for transmission; and
the slower clock rate is to be used on a digital-to-analog converter in the wireless communications device.

12. The apparatus of claim 11, wherein the wireless communications device is further to:
determine a set of wireless communications devices to be targeted by the second frame, each device in the set of wireless communications devices determined to be able to process the second frame at a lower clock rate than needed for processing the first frame.

13. The apparatus of claim 11, wherein:
said wireless communications comprise multi-band OFDM (MB-OFDM) communications;
said first subset of adjacent RF carriers from the first set of RF carriers is defined as a first band of the MB-OFDM communications, and a second subset of adjacent RF carriers from the first set of RF carriers is defined as a second band of the MB-OFDM communications.

14. The apparatus of claim 13, wherein the first band and the second band do not contain any of the same carriers.

15. An article comprising
a tangible computer-readable medium that contains instructions, which when executed by one or more processors result in performing operations comprising:
processing a first orthogonal frequency division multiplexing (OFDM) frame for wireless communications, the first OFDM frame based on a first set of radio frequency (RF) carriers and a first symbol duration;
processing a second OFDM frame for wireless communications, the second OFDM frame based on a second set of RF carriers and a second symbol duration;
selecting a slower clock rate for the second frame than the first frame, the clock rate to be used in at least a portion of circuitry used for said processing of the first and second frames;
wherein the second frame is different than the first frame in at least one of the following ways:
a) the second set of RF carriers is a first subset of adjacent RF carriers from the first set of RF carriers; and
b) the second symbol duration is greater than the first symbol duration.

16. The medium of claim 15, wherein:
the operation of processing the first frame comprises processing the first frame after reception of the first frame and said processing the second frame comprises processing the second frame after reception of the second frame; and
the operation of using the slower clock rate comprises using a slower clock rate for an analog-to-digital converter.

17. The medium of claim 15, wherein:
the operation of processing the first and second frames comprises processing the first and second frames for transmission; and
the operation of using the slower clock rate comprises using a slower clock rate for a digital-to-analog converter.

18. The medium of claim 17, wherein the operation further comprise:
determining a set of wireless communications devices to be targeted by the second frame, each device in the set of wireless communications devices determined to be able to process the second frame at a lower clock rate than needed for processing the first frame.

19. The medium of claim 17, wherein:
said wireless communications comprise multi-band OFDM (MB-OFDM) communications;
said first subset of adjacent RF carriers from the first set of RF carriers are used to form a first band of the MB-OFDM communications, and a second subset of adjacent RF carriers from the first set of RF carriers are used to form a second band of the MB-OFDM communications.

20. A method, comprising:
processing a radio frequency (RF) signal containing multiple carriers of an orthogonal frequency division multiplexed (OFDM) communications frame;
converting the RF signal to produce a time-domain signal and a frequency-domain signal that is conjugate-symmetric with the time-domain signal;
processing the time-domain signal, and removing power from a part of processing circuitry for processing the frequency-domain signal.

21. The method of claim 20, wherein said removing power comprises removing power from a first analog-to-digital converter.

22. The method of claim 21, wherein said processing the time-domain signal comprises providing power to a second analog-to-digital converter.
